(19) United States
(12) Patent Application Publication
(10) Pub. No.: US 2003/0195114 A1
(43) Pub. Date: Oct. 16, 2003

(54) Supported catalyst

(76) Inventors: Thomas Tacke, Alzenau (DE); Helmfried Krause, Rodenbach (DE); Hermanus Gerhardus Jozef Lansink Rotgerink, Mombris-Mensengesass (DE); Baoshu Chen, Paducah, KY (US); Jason Carson, Kirksey, KY (US)

Correspondence Address: SMITH, GAMBRELL & RUSSELL, LLP, SUITE 3100, PROMENADE II, 1230 PEACHTREE STREET, N.E., ATLANTA, GA, 30309-3592, US

(21) Appl. No.: 10/325,705

(22) Filed: Dec. 20, 2002

(30) Foreign Application Priority Data
Dec. 21, 2001 (DE) 101 63 180.4

(51) Int. Cl. B01J 23/58

(52) U.S. Cl. 502/328; 502/330; 502/439

(57) ABSTRACT

Moulded body based on pyrogenically prepared silicon dioxide, having an annular cylindrical form, the cross section of which has a void and wherein the free surface area accounts for from 1.6 to 77% of the total surface area of the cross section. Supported catalyst which contains on a support (moulded body) as the catalytically active components palladium and/or compounds and alkali metal compounds thereof, as well as additionally gold and/or compounds thereof (Pd/alkali metal/Au system) or cadmium and/or compounds thereof (Pd/alkali metal/Cd system) or barium and/or components thereof (Pd/alkali metal/Ba system) or palladium, alkali metal compounds and mixtures of gold and/or cadmium and/or barium. The catalyst is on a support having a channel which passes through it, and the active components exhibit a penetration depth of more than 0.5 mm to 1.5 mm, calculated from the surface of the support material. The supported catalyst are utilized for the production of unsaturated esters from olefins in the gas phase.

### INTRODUCTION AND BACKGROUND

The present invention relates to a supported catalyst, a process for the preparation thereof as well as to the use thereof, as well as to moulded bodies based on pyrogenically prepared oxides. The invention relates in particular to a catalyst on annular extrudates for the acetoxylation of olefins, such as, for example, the production of vinyl acetate monomer by the gas-phase process.

The invention relates furthermore to annular extrudates and to a process for the preparation thereof as well as to the use thereof.

Processes for the production of vinyl acetate monomer are known from DE 16 68 088, EP-A 0 464 633, EP-A 0 519 435, EP-A 0 634 208, EP-A 0 723 810, EP-A 0 634 209, EP-A 0 632 214, EP-A 0 654 301, EP-A 0 723 810, U.S. Pat. No. 4,048,096, U.S. Pat. No. 5,185,308 and U.S. Pat. No. 5,371,277. These documents also describe processes for the preparation of supported catalysts. Depending on the embodiment, supported catalysts are prepared having homogeneous precious metal distribution over the cross section of the support and having a shell profile which may be more or less pronounced.

It is known from DE-B 21 00 778, U.S. Pat. No. 4,902,823, U.S. Pat. No. 5,250,487, U.S. Pat. No. 5,292,931, U.S. Pat. No. 5,808,136, EP 0 807 615, EP 0 916 402 and EP 0 987 058 to utilize moulded bodies based on pyrogenically prepared silicon dioxides as catalyst supports in the production of vinyl acetate monomer.

EP-A 0 464 633 describes a supported catalyst for the production of vinyl acetate monomer, based on a catalyst support having at least one channel which passes through it. In particular, reference is to a hollow cylinder in which at least 95% of the palladium, gold and/or compounds thereof are located within a region extending from the surface to 0.5 mm below the surface of the support. Such supported catalysts show with reduced pressure loss an adequate activity and/or selectivity over the catalyst bed.

It is an object of the invention to prepare a supported catalyst which has a higher activity than known catalysts, at the same or improved selectivity.

### SUMMARY OF THE INVENTION

The above and other objects of the present invention can be achieved by a supported catalyst which contains on a support (moulded body) as the catalytically active components palladium and/or compounds thereof and alkali metal compounds thereof, as well as additionally gold and/or compounds thereof (Pd/alkali metal/Au system) or cadmium and/or compounds thereof (Pd/alkali metal/Cd system) or barium and/or compounds thereof (Pd/alkali metal/Ba system) or palladium, alkali metal compounds and mixtures of gold and/or cadmium and/or barium, which is characterized in that it is a catalyst on a support having a channel which passes through it, and the active components exhibit a penetration depth of more than 0.5 mm to 1.5 mm, preferably more than 0.5 mm to 1.0 mm, calculated from the surface of the support material.

The invention can preferably provide a supported catalyst which contains on a support (moulded body) as the catalytically active components palladium and/or compounds thereof and alkali metal compounds thereof, as well as additionally gold and/or compounds thereof (Pd/alkali metal/Au system) or cadmium and/or compounds thereof (Pd/alkali metal/Cd system) or barium and/or compounds thereof (Pd/alkali metal/Ba system) or palladium, alkali metal compounds and mixtures of gold and/or cadmium and/or barium, which is characterized in that the support is a hollow cylinder, an annular tablet or an annular extrudate having a channel which passes through it, based on silicon dioxide, aluminum silicates and other raw materials which are stable under the conditions under which the catalyst is prepared and is stable under the process conditions during vinyl acetate monomer production by the gas-phase process.

The invention also provides moulded bodies characterized by an annular cylindrical form wherein the cross section exhibits a void and wherein the free surface area is from 1.6 to 77% of the total surface area.

### DETAILED DESCRIPTION OF THE INVENTION

In one embodiment of the invention the supported catalyst can be embodied such that the support material is a moulded body prepared from one or more pyrogenic oxides and/or mixed oxides from the series SiO₂, Al₂O₃, TiO₂ and ZrO₂.

The supported catalyst can furthermore be embodied such that the support material is a moulded body prepared from pyrogenic mixed oxides, wherein at least two oxides from the group SiO₂, Al₂O₃, TiO₂ and ZrO₂ are used.

In a particular embodiment of the invention the support material can be a moulded body prepared from pyrogenically prepared silicon dioxide, wherein the moulded body has the following physico-chemical characteristics:

| | | |
|---|---|---|
| External diameter | 3-8 | mm |
| Internal diameter | ≧1 | mm |
| Proportion of void surface area | 1.6-77% | |
| as % of total cross section: | | |
| BET surface area: | 5-400 | m²/g |

The moulded bodies based on pyrogenic silicon dioxide can be characterized by an annular cylindrical form wherein the cross section exhibits a void, and wherein the free surface area ranges from 1.6 to 77%, preferably 1.6 to 56%, of the total surface area of the cross section.

The moulded body can be a hollow cylinder, an annular tablet and/or an annular extrudate.

Potassium compounds such as, for example, potassium acetate, are preferably used as the alkali metal compounds.

The catalytically active components may be present in the following systems:

Pd/Au/alkali metal compounds

Pd/Cd/alkali metal compounds

Pd/Ba/alkali metal compounds.

In a preferred embodiment of the invention the supported catalyst exhibits the Pd/K/Au system as the active components.

Further components and/or promoters to increase catalyst activity and/or catalyst selectivity are contemplated.

The supported catalysts according to the invention can be used for the production of unsaturated esters from olefins, organic acids and oxygen in the gas phase. In particular the supported catalysts according to the invention can be used for the production of vinyl acetate monomer. For this purpose, ethene, ethanoic acid and molecular oxygen or air are reacted in the gas phase, optionally with the addition of inert gases, at temperatures of from 100 to 250° C. and at standard or elevated pressure, for example from 1 to 25 bar, in the presence of the supported catalyst according to the invention. Typically, spatial velocities of from 1000 to 5000 litres gas mixture, in relation to the gas phase, are achieved per litre of catalyst and per hour.

The catalysts according to the invention can also be utilized for the acetoxylation of olefins such as, for example, propene.

The invention also provides a process for the preparation of the herein defined supported catalyst by, in a suitable order, soaking, spray application, vapour deposition, immersion or precipitation of the Pd metal compounds, Au metal compounds, Cd metal compounds, Ba metal compounds, optionally reduction of the reducible metal compounds applied to the support, washing to remove optionally present chloride content, impregnation with alkali metal acetates or with alkali metal compounds which under the reaction conditions during vinyl acetate monomer production convert wholly or partially to alkali metal acetates, wherein the support is a support having a channel which passes through it. The support may be a hollow cylinder, an annular tablet and/or an annular extrudate.

The invention also provides a process for the preparation of the herein defined supported catalyst by impregnation of the support with a basic solution and with a solution which contains gold salts and palladium salts, wherein the impregnation takes place at the same time or sequentially, with or without intermediate drying, washing of the support to remove optionally present chloride content, and, before or after washing, reduction of the insoluble compounds precipitated on the support, drying of the catalyst precursor thus obtained, and impregnation with alkali metal acetates or with alkali metal compounds, in particular potassium acetate, which under the reaction conditions during vinyl acetate monomer production convert wholly or partially to alkali metal acetates, wherein the support has a channel which passes through it. The support may be a hollow cylinder, an annular tablet and/or an annular extrudate. The support can be in particular a moulded body based on pyrogenically prepared annular extrudates.

In the case of Pd/alkali metal/Ba catalysts the metal salts can be applied by known methods such as soaking, spray application, vapour deposition, immersion or precipitation (EP 0 519 436). The same methods are known in the case of Pd/alkali metal/Cd catalysts (U.S. Pat. No. 4,902,823, U.S. Pat. No. 3,393,199, U.S. Pat. No. 4,668,819).

Depending on the catalyst system, a reduction of the supported catalyst can be carried out.

The reduction of the catalyst can be carried out in the aqueous phase or in the gas phase.

Formaldehyde or hydrazine, for example, are suitable for the reduction in the aqueous phase.

The reduction in the gas phase can be carried out with hydrogen, or forming gas (95 vol. % N₂+5 vol. % H₂), ethene or nitrogen-diluted ethene.

According to EP 0 634 209, the reduction can take place with hydrogen at temperatures of between 40 and 260° C., preferably between 70 and 200° C.

According to EP-A 0 723 810, the reduction takes place with forming gas (95 vol. % N₂ and 5 vol. % H₂) at temperatures of between 300 and 550° C., preferably between 350 and 500° C.

In the process for the production of vinyl acetate monomer, loading of the catalyst with the reactants proceeds only slowly. The activity of the catalyst increases during this starting-up phase, normally reaching its final level only after days or weeks.

It is important that the catalyst supports retain their mechanical strength under the reaction conditions of the catalytic process, in particular under the influence of ethanoic acid.

The supported catalyst according to the invention achieves a markedly improved product yield owing to increased activity and/or improved selectivity.

The preparation of the supported catalysts according to the invention is described in greater detail hereinbelow, taking as an example the Pd/alkali metal/Au system.

According to one embodiment of the invention, moulded bodies, in particular in the form of hollow cylinders (annular extrudates), are impregnated with a solution which contains palladium and gold. At the same time as the precious metal-containing solution or in any order sequentially, the support materials which are utilized can be impregnated with a basic solution which can contain one or more basic compounds. The basic compound or compounds serves or serve to convert the palladium and the gold to their hydroxides.

The compounds in the basic solution can comprise alkali metal hydroxides, alkali metal bicarbonates, alkali metal carbonates, alkali metal silicates or mixtures of these substances. Potassium hydroxide, sodium hydroxide and/or sodium metasilicate are preferably used.

Palladium chloride, sodium palladium chloride or potassium palladium chloride or palladium nitrate can, for example, be used as the palladium salts for the preparation of the precious metal-containing solution.

Gold(III) chloride and tetrachloroauric(III) acid are suitable as the gold salts.

Potassium palladium chloride, sodium palladium chloride and/or tetrachloroauric acid are preferably used.

The impregnation of the catalyst support with the basic solution influences the deposition of the precious metals on the catalyst support. The basic solution can be brought into contact with the catalyst support either at the same time as the precious metal solution or in any order with the latter solution. When the catalyst support is impregnated with the two solutions in sequence, an intermediate drying can be carried out following the first impregnation step.

The catalyst support is preferably impregnated first with the basic compound. The subsequent impregnation with the solution which contains palladium and gold is able to bring about the precipitation of palladium and gold in a surface shell on the catalyst support. Impregnations in reverse order can generally result in a greater or lesser degree of homogeneity in the distribution of the precious metals over the cross section of the catalyst support. With a suitable reaction regime, however, even when the order of impregnation is reversed, catalysts having a defined shell can be obtained (US 4,048,096). Catalysts having homogeneous or virtually homogeneous precious metal distribution generally exhibit a lower activity and selectivity.

The shell thickness can be influenced by the quantity of the basic compound applied to the support material in relation to the desired quantity of precious metals. The higher this ratio, the less thick is the shell which forms. The quantitative ratio of basic compound to the precious metal compounds which is necessary for a desired shell thickness can depend on the nature of the support material as well as on the basic compound and the precious metal compounds selected. The quantitative ratio which is necessary is expediently determined by means of a little preliminary experimentation. The shell thickness which results can in this case be determined easily by cutting open the catalyst particles.

The minimum necessary quantity of basic compound results from the stoichiometrically calculated quantity of hydroxide ions required to convert the palladium and the gold to the hydroxides. As a guide value, for a shell thickness of up to 1.0 mm the basic compound should be employed in a stoichiometric excess of 1 to 10-times.

Catalyst supports can be coated with the basic compounds and the precious metal salts by the process of pore volume impregnation. If the intermediate drying is effected, the volumes of the two solutions are selected such as to correspond in each case to approximately 90 to 100% of the adsorption capacity of the catalyst support. If the intermediate drying is omitted, then the sum of the individual volumes of the two impregnating solutions must correspond to the above condition, wherein the individual volumes can be in a mutual ratio of from 1:9 to 9:1. A volumetric ratio of from 3:7 to 7:3, in particular of 1: 1, is preferably employed. In both cases water can preferably be used as the solvent. However, suitable organic or aqueous-organic solvents can also be utilized.

The reaction of the precious metal salt solution with the basic solution to give insoluble precious metal compounds takes place slowly and is generally concluded after from 1 to 24 hours, depending on the method of preparation. The water-insoluble precious metal compounds are then treated with reducing agents. A wet reduction, for example with aqueous hydrazine hydrate, or a gas phase reduction with hydrogen, ethene, or forming gas can be carried out. The reduction can take place at standard temperature or elevated temperature and at standard pressure or elevated pressure, optionally also with the addition of inert gases such as, for example, nitrogen.

Before and/or following the reduction of the precious metal compounds, the chloride which is optionally present on the support can be removed by thorough washing. Following washing, the catalyst can contain less than 500, preferably less than 200 ppm chloride.

The catalyst precursor obtained following the reduction can be dried and be subsequently impregnated with alkali metal acetates or with alkali metal compounds which under the reaction conditions during vinyl acetate monomer production convert wholly or partially to alkali metal acetates. Impregnation can preferably be effected with potassium acetate. Here, pore volume impregnation can again preferably be used. That is to say: the required quantity of potassium acetate is dissolved in a solvent, preferably water, whereof the volume corresponds approximately to the adsorption capacity of the support material which is presented for the selected solvent. This volume is approximately equal to the total pore volume of the support material.

The finished catalyst can then be dried to a residual moisture content of less than 5%. The drying can take place in air, optionally also under nitrogen as an inert gas.

The supported catalysts of the Pd/alkali metal/Cd and Pd/alkali metal/Ba systems on suitable support materials can be prepared in accordance with the patent specifications cited above.

For the synthesis of vinyl acetate monomer, it is expedient to coat the catalyst with from 0.2 to 4, preferably 0.3 to 3 wt. % palladium, from 0.1 to 2, preferably 0.15 to 1.5 wt. % gold and from 1 to 10, preferably 1.5 to 9 wt. % potassium acetate, in each case in relation to the weight of the support utilized. These data apply to the Pd/alkali metal/Au system.

In the case of catalyst supports having a bulk density of 500 g/l, these concentration data correspond to volume-related concentrations of from 1.0 to 20 g/l palladium, from 0.5 to 10 g/l gold and from 5 to 50 g/l potassium acetate.

In order to prepare the impregnating solutions, the corresponding quantities of the palladium compounds and gold compounds can be dissolved in a volume of water corresponding to approximately 10 to 100% of the water adsorption capacity of the support material presented. This procedure can likewise be used in the preparation of the basic solution.

The cadmium content of the Pd/alkali metal/Cd catalysts can be from 0.1 to 2.5 wt. %, preferably 0.4 to 2.0 wt. %.

The barium content of the Pd/alkali metal/Ba catalysts can be from 0.1 to 2.0 wt. %, preferably 0.2 to 1.8 wt. %.

The palladium content of the Pd/alkali metal/Cd and of the Pd/alkali metal/Ba catalysts, respectively, can be from 0.2 to 4 wt. %, preferably 0.3 to 3 wt. % palladium.

The potassium content of the Pd/alkali metal/Cd and of the Pd/alkali metal/Ba catalysts can be from 1 to 10 wt. %, preferably 1.5 to 9 wt. %.

In a particular embodiment of this invention a support material based on annular extrudates prepared from pyrogenically prepared silicon dioxide having the following physico-chemical characteristics can be utilized:

| | | |
|---|---|---|
| External diameter | 3-8 | mm |
| Internal diameter | ≧1 | mm |
| Proportion of void surface area as % of | 1.6-77% | |
| total cross section: | | |
| BET surface area: | 5-400 | m²/g |

The process for the preparation of these preferred catalyst supports is characterized in that pyrogenically prepared silicon dioxide is compacted with methylhydroxypropyl cellulose and/or wax emulsion and/or polysaccharide with the addition of weakly ammoniacal water. Polyethylene oxide is optionally added in order to improve the slip of the composition during extrusion, the composition is extruded, dried at a temperature of from 30 to 150° C., and the annular extrudates obtained are after-baked at a temperature of from 400 to 1200° C. for a duration of from 0.5 to 8 hours. All mixers and kneaders which enable good homogenization, such as, for example, ploughshare mixers, intensive mixers, sigma-type mixers, Z-shaped blade mixers, are suitable for carrying this out.

The moulded bodies can be prepared on plunger-type extruders, single- or twin-screw extruders.

In a particular embodiment, before moulding, composition which is composed as follows can be prepared with water:

| | | |
|---|---|---|
| 70-98 | wt. % | silicon dioxide, preferably 85-95 wt. % |
| 0.1-20 | wt. % | methylhydroxypropyl cellulose, preferably 1-10 wt. % |
| 0.1-20 | wt. % | wax emulsion, preferably 2-10 wt. % |
| 0.1-5 | wt. % | polysaccharide, preferably 0.2-1.5 wt. % |
| 0.1-5 | wt. % | polyethylene oxide, preferably 0.2-2 wt. % |

The annular extrudates can take forms having the following dimensions:

| | | |
|---|---|---|
| External diameter | 3-8 | mm |
| Internal diameter | ≧1 | mm |
| Proportion of void surface area as % | 1.6-77% | |
| of total cross section: | | |

The annular extrudates can be after-baked at from 400 to 1200° C. for from 30 minutes to 8 hours. Following the after-baking, they can then be utilized as catalyst supports.

The breaking strength, pore volume and specific surface can be adjusted by varying the feed materials and the after-baking temperature.

Silicon dioxides having physico-chemical characteristics in accordance with Table 1 can be utilized as pyrogenically prepared silicon dioxide:

TABLE 1

| Testing method | | Aerosil 90 | Aerosil 130 | Aerosil 150 | Aerosil 200 | Aerosil 300 | Aerosil 380 |
|---|---|---|---|---|---|---|---|
| Water character | hydrophilic | | | | | | |
| Appearance | loose white powder | | | | | | |
| BET¹ surface area | m²/g | 90 ± 15 | 130 ± 25 | 150 ± 15 | 200 ± 25 | 300 ± 30 | 380 ± 30 |
| Average primary | nm | 20 | 16 | 14 | 12 | 7 | 7 |
| particle size | | | | | | | |
| Compacted bulk density | g/l | 80 | 50 | 50 | 50 | 50 | 50 |
| (approx. value)² | | | | | | | |
| Drying loss³ | % | <1.0 | <1.5 | <0.5⁹⁾ | <1.5 | <1.5 | <2.0 |
| (2 hours at 105° C.) on | | | | | | | |
| leaving supplier's works | | | | | | | |
| Ignition loss^{4 7} | % | <1 | <1 | <1 | <1 | <2 | <2.5 |
| 2 hours at 1000° C.) | | | | | | | |
| pH⁵ | 3.7-4.7 | 3.7-4.7 | 3.7-4.7 | 3.7-4.7 | 3.7-4.7 | 3.7-4.7 | 3.7-4.7 |
| SiO₂⁸ | % | >99.8 | >99.8 | >99.8 | >99.8 | >99.8 | >99.8 |
| Al₂O₃⁸ | % | <0.05 | <0.05 | <0.05 | <0.05 | <0.05 | <0.05 |
| Fe₂O₃⁸ | % | <0.003 | <0.003 | <0.003 | <0.003 | <0.003 | <0.003 |
| TiO₂⁸ | % | <0.03 | <0.03 | <0.03 | <0.03 | <0.03 | <0.03 |
| HCl^{8 10} | % | <0.025 | <0.025 | <0.025 | <0.025 | <0.025 | <0.025 |
| Sieving residue⁶ | % | <0.05 | <0.05 | <0.05 | <0.05 | <0.05 | <0.05 |
| (in accordance with | | | | | | | |
| Mocker, 45 mm) | | | | | | | |

¹in accordance with DIN 66131
²in accordance with DIN ISO 787/XI, JIS K 5101/18 (not sieved)
³in accordance with DIN ISO 787/II, ASTM D 280, JIS K 5101/21
⁴in accordance with DIN 55921, ASTM D 1208, JIS K 5101/23
⁵in accordance with DIN ISO 787/IX, ASTN D 1208, JIS K 5101/24
⁷in relation to substance dried at 105° C. for 2 hours
⁸in relation to substance ignited at 1000° C. for 2 hours
⁹special moisture-protective packaging

In order to prepare the pyrogenically prepared silicon dioxide (for example AEROSIL® from Degussa) a volatile silicon compound is injected into an oxyhydrogen flame. In the majority of cases silicon tetrachloride is used. This substance hydrolyzes under the influence of the water arising in the oxyhydrogen reaction to give silicon dioxide and hydrochloric acid. After leaving the flame, the silicon dioxide enters a so-called coagulation zone in which the AEROSIL® primary particles and the AEROSIL® primary aggregates agglomerate. The product which is present in this stage as a type of aerosol is freed from the gaseous accompanying substances and is then post-treated with moist hot air. The residual hydrochloric acid content can be reduced to below 0.025% by this process. As the AEROSIL® arises at the end of this procedure having a bulk density of only approx. 15 g/l, a vacuum compression follows which enables compacted bulk densities of approx. 50 g/l and higher to be adjusted.

The particle sizes of the products obtained in this manner can be varied with the aid of the reaction conditions such as, for example, flame temperature, hydrogen or oxygen content, silicon tetrachloride quantity, residence time in the flame or length of the coagulation zone.

The BET surface area is determined with nitrogen in accordance with DIN 66 131.

The pore volume is determined mathematically from the sum of the micropore, mesopore and macropore volumes.

The breaking strength is determined by means of the breaking strength tester from Erweka, model TBH 28.

The micropores and mesopores are determined by recording an N₂ isotherm and evaluating it in accordance with BET, de Boer and Barret, Joyner, Halenda.

The macropores are determined by the mercury injection method.

Abrasion is determined by means of the abrasion and friability tester from Erweka, model TAR.

### EXAMPLE 1

| | | |
|---|---|---|
| 94.3 | wt. % | Aerosil ® 380 |
| 1.9 | wt. % | methylhydroxypropyl cellulose |
| 3.3 | wt. % | wax emulsion |
| 0.5 | wt. % | polysaccharide |

are compacted in a mixer with the addition of water adjusted with an aqueous ammoniacal solution (12 ml of a 25% solution per 1 kg batch) to be weakly alkaline. This composition is moulded in a single-screw extruder to form annular extrudates and is cut to the desired length with a cutting device. The moulded bodies are dried at 120° C. on a belt dryer and are then calcined at 900° C. for 3 hours.

### EXAMPLE 2

| | | |
|---|---|---|
| 93.0 | wt. % | Aerosil ® 200 |
| 3.25 | wt. % | methylhydroxypropyl cellulose |
| 9.25 | wt. % | wax emulsion |
| 0.5 | wt. % | polysaccharide |

are compacted in a mixer with the addition of water adjusted with an aqueous ammoniacal solution (12 ml of a 25% solution per 1 kg batch) to be weakly alkaline. The composition is moulded in a single-screw extruder to form annular extrudates and is cut to the desired length with a cutting device. The moulded bodies are dried at 120° C. on a belt dryer and are then calcined at 900° C. for 3 hours.

### EXAMPLE 3

Annular extrudates as described in Example 2 are prepared. However, calcining is at 850° C. for 3 hours.

### EXAMPLE 4

| | | |
|---|---|---|
| 93.0 | wt. % | Aerosil ® 380 |
| 3.25 | wt. % | methylhydroxypropyl cellulose |
| 3.25 | wt. % | wax emulsion |
| 0.5 | wt. % | polysaccharide |

are compacted in a mixer with the addition of water adjusted with an aqueous ammoniacal solution (12 ml of a 25% solution per 1 kg batch) to be weakly alkaline. The composition is moulded in a single-screw extruder to form annular extrudates and is cut to the desired length with a cutting device. The moulded bodies are dried at 120° C. on a belt dryer and are then calcined at 900° C. for 3 hours.

### EXAMPLE 5

Annular extrudates as described in Example 4 are prepared. However, calcining is at 850° C.

### EXAMPLE 6

| | | |
|---|---|---|
| 93.0 | wt. % | Aerosil ® 380 |
| 2.8 | wt. % | methylhydroxypropyl cellulose |
| 2.3 | wt. % | wax emulsion |
| 1.4 | wt. % | polyethylene oxide |
| 0.5 | wt. % | polysaccharide |

are compacted in a mixer with the addition of water adjusted with an aqueous ammoniacal solution (12 ml of a 25% solution per 1 kg batch) to be weakly alkaline. The composition is moulded in a single-screw extruder to form annular extrudates and is cut to the desired length with a cutting device. The moulded bodies are dried at 120° C. on a belt dryer and are then calcined at 850° C. for 3 hours.

TABLE 2

| Example | 1 | 2 | 3 | 4 | 5 | 6 |
|---|---|---|---|---|---|---|
| Breaking | 24 | 27 | 24 | 44 | 34 | 24 |
| strength (N) | | | | | | |
| Abrasion (wt. %) | 2.25 | 3.75 | 5.2 | 1.5 | 2.5 | 5.3 |
| Water pore | 0.62 | 0.90 | 1.02 | 0.65 | 0.81 | 0.94 |
| volume (ml/g) | | | | | | |
| Compacted bulk | n.d. | 375 | 340 | 465 | 400 | 315 |
| density g/l | | | | | | |
| Diameter (mm) | | | | | | |
| External | 5.02 | 5.3 | 5.4 | 4.6 | 4.8 | 5.7 |
| Internal | 2.8 | 2.2 | 2.3 | 1.9 | 2.0 | 3.0 |
| Proportion of | 31 | 17 | 18 | 17 | 17 | 28 |
| void surface area | | | | | | |
| as % of total | | | | | | |
| cross section | | | | | | |
| Specific surface | n.d. | 140 | 163 | 157 | 192 | n.d. |
| (m²/g) | | | | | | |

The moulded bodies according to the invention have or enable:

low pressure losses

low bulk densities

relatively high external surface areas per unit volume of a reaction vessel

good mass transfer and thermal transmission

and in particular a markedly higher breaking strength and abrasion resistance than known hollow cylinders and other support forms such as also, for example, support materials of honeycomb form.

The Examples which follow illustrate the efficiency of the supported catalyst according to the invention based on hollow cylinders (annular extrudates). In particular, reference is made here to annular extrudates based on pyrogenically prepared oxides.

As to their precious metal dispersion the catalysts are characterized, inter alia, by pulse chemisorption with carbon monoxide. The Micromeritics instrument (model No. 2910) is utilized here. Because the catalysts are bimetallic systems, the dispersion data are not given as a percentage. Instead, purely the adsorption of carbon monoxide is determined by pulse chemisorption and this is taken as a comparison for the dispersion of the catalysts.

### EXAMPLE 7 (COMPARISON EXAMPLE)

A palladium-gold-potassium acetate catalyst based on Example 1 according to EP-A 0 464 633 is prepared. A support according to Example 5 is utilized as the catalyst support. The concentration of the impregnating solutions is selected such that the finished catalyst contains a concentration of 0.55 wt. % palladium, 0.25 wt. % gold and 5.0 wt. % potassium acetate. The catalyst has a CO adsorption, measured by pulse chemisorption, of 0.108 ml/g and a shell thickness, in relation to palladium and gold, of 0.1 mm.

This is catalyst A and is not according to the invention.

### EXAMPLE 8 (COMPARISON EXAMPLE)

A palladium-gold-potassium acetate catalyst based on Example 1 according to EP-A 0 464 633 is prepared. A support according to Example 5 is utilized as the catalyst support. The concentration of the impregnating solutions and the method of preparation are adapted such that the finished catalyst contains a concentration of 0.55 wt. % palladium, 0.25 wt. % gold and 5.0 wt. % potassium acetate and exhibits a complete penetration depth in relation to palladium and gold. The catalyst exhibits a CO adsorption, measured by pulse chemisorption, of 0.212 ml/g.

This is catalyst B and is not according to the invention.

### EXAMPLE 9

A palladium-gold-potassium acetate catalyst is prepared based on the catalyst support according to Example 5. The concentration of the impregnating solutions is selected such that the finished catalyst contains a concentration of 0.55 wt. % palladium, 0.25 wt. % gold and 5.0 wt. % potassium acetate.

In an initial step the support is first impregnated with a basic solution of sodium hydroxide in water. The volume of aqueous NaOH solution corresponds to 50 per cent of the water adsorption of the dry support. Following impregnation with sodium hydroxide, without intermediate drying, the support is impregnated immediately with an aqueous precious metal solution of sodium palladium chloride and tetrachloroauric acid, wherein the volume likewise corresponds to 50 per cent of the water adsorption capacity of the dry support material.

Following a waiting period of 1.5 hours in order for the precious metal compounds to hydrolyze, the support particles are washed free of chloride. The catalyst is dried and is reduced with forming gas in the gas phase at 450° C. The catalyst is afterwards impregnated with an aqueous potassium acetate solution and is dried again. The drying is carried out in the gas phase with air.

The sodium hydroxide concentration of the basic solution is calculated such that a precious metal-containing shell of <1.0 mm forms on the support particles. The catalyst exhibits a CO adsorption, measured by pulse chemisorption, of 0.178 ml/g and a shell thickness, in relation to palladium and gold, of more than 0.6 mm, with 0.8 mm not, however, being exceeded. This catalyst likewise contains 0.55 wt. % palladium, 0.25 wt. % gold and 5.0 wt.% potassium acetate.

This is catalyst C according to the invention.

### EXAMPLE 10

Catalysts A and B (Examples 7 and 8) which are not according to the invention, as well as catalyst C (Example 9) according to the invention are examined in a performance test during vinyl acetate monomer (VAM) production.

The activity and selectivity of the catalysts as well as the vinyl acetate monomer yield are measured in a screening test during testing of up to 80 hours' duration.

For this purpose, 20.0 ml of each of the individual catalysts are tested after their dilution with inert material with the following gas composition: 66.0 vol. % ethene, 18.0 vol. % ethanoic acid, 6.0 vol- % oxygen and 10.0 vol. % nitrogen in a tubular flow reactor heated with oil to 150° C. (reactor length 710 mm, internal diameter 23.7 mm) at 4 bar positive pressure and at a spatial velocity (GHSV) of 5000 h⁻¹.

The reaction products are analyzed on-line in the reactor outlet by means of gas chromatography. In order to evaluate the individual catalysts, the vinyl acetate monomer yield as a percentage is used, with the values being standardized and catalyst A according to Example 7 being set at 100 per cent. Catalyst A corresponds to the prior art according to EP 0 464 633 A.

The test results are set out in Table 3.

TABLE 3

| | Relative | Catalyst |
|---|---|---|
| Catalyst | VAM yield as [%] | temperature [° C.] |
| A (not according to the | 100 | 154.8 |
| invention) | | |
| B (not according to the | 75.1 | 155.3 |
| invention) | | |
| C (according to the | 123.0 | 155.8 |
| invention) | | |

Catalyst A (annular extrudates having a shell thickness in relation to palladium and gold of less than 0.5 mm) exhibits a markedly higher vinyl acetate monomer yield than catalyst B in accordance with Example 8.

Catalyst B has a homogeneous distribution of palladium and gold over the cross section of the support. The results of EP 0 464 633 are thus confirmed.

It is, however, surprisingly demonstrated that catalyst C according to the invention in accordance with Example 9, which has a shell thickness of from 0.5 to 1.0 mm in relation to palladium and gold, exhibits the highest vinyl acetate monomer yield.

Further variations and modifications of the foregoing will be apparent to those skilled in the art and are intended to be encompassed by the claims appended hereto.

German priority application 101 63 180.4 is relied on and incorporated herein by reference.

We claim:

1. A supported catalyst comprising a shaped support containing, as a catalytically active component
(a) at least one catalytically active compound selected from the group consisting palladium and palladium compounds;
(b) an alkali metal compound and
(c) at least one additional compound selected from the group consisting of gold, a gold compound, cadmium, a cadmium compound, barium, a barium compound; or
(d) palladium, an alkali metal compound and mixtures of at least two of gold, cadmium and barium,
wherein the support has a channel which passes through the support and the active components exhibit a penetration depth of from more than 0.5 mm to 1.5 mm, calculated from the surface of the support.

2. The supported catalyst according to claim 1, wherein the active component exhibits a penetration depth of from more than 0.5 to 1.0 mm, calculated from the surface of the support.

3. The supported catalyst according to claim 1, wherein the support material is a moulded body which is prepared from pyrogenically prepared silicon dioxide, wherein the moulded body has the following physico-chemical characteristics:

| | | |
|---|---|---|
| External diameter | 3-8 | mm |
| Internal diameter | ≧1 | mm |
| Proportion of void surface area | 1.6-77% | |
| as % of total cross section: | | |
| BET surface area: | 5-400 | m²/g. |

4. The supported catalyst according to claim 2, wherein the support material is a moulded body which is prepared from pyrogenically prepared silicon dioxide, wherein the moulded body has the following physico-chemical characteristics:

| | | |
|---|---|---|
| External diameter | 3-8 | mm |
| Internal diameter | ≧1 | mm |
| Proportion of void surface area | 1.6-77% | |
| as % of total cross section: | | |
| BET surface area: | 5-400 | m²/g. |

5. The supported catalyst according to claim 1, wherein the support material is a moulded body prepared from a pyrogenic oxide selected from the group SiO₂, Al₂O₃, TiO₂, ZrO₂ and mixtures thereof.

6. The supported catalyst according to claim 2, wherein the support material is a moulded body prepared from a pyrogenic oxide selected from the group SiO₂, Al₂O₃, TiO₂, ZrO₂ and mixtures thereof.

7. The supported catalyst according to claim 1, wherein the support material is a moulded body prepared from pyrogenic mixed oxides, wherein at least two oxides selected from the group consisting of SiO₂, Al₂O₃, TiO₂ and ZrO₂ are used.

8. The supported catalyst according to claim 2, wherein the support material is a moulded body prepared from pyrogenic mixed oxides, wherein at least two oxides selected from the group consisting of SiO₂, Al₂O₃, TiO₂ and ZrO₂ are used.

9. The supported catalyst according to claim 1, wherein Pd/K/Au is the active component.

10. The supported catalyst according to claim 2, wherein Pd/K/Au is the active component.

11. The supported catalyst according to claim 3, wherein Pd/K/Au is the active component.

12. The supported catalyst according to claim 4, wherein Pd/K/Au is the active component.

13. The supported catalyst according to claim 5, wherein Pd/K/Au is the active component.

14. The supported catalyst according to claim 1, wherein the alkali metal compound is potassium acetate.

15. The supported catalyst according to claim 2, wherein the alkali metal compound is potassium acetate.

16. The supported catalyst according to claim 3, wherein the alkali metal compound is potassium acetate.

17. The supported catalyst according to claim 4, wherein the alkali metal compound is potassium acetate.

18. The supported catalyst according to claim 5, wherein the alkali metal compound is potassium acetate.

19. The supported catalyst according to claim 6, wherein the alkali metal compound is potassium acetate.

20. A process for the preparation of the supported catalyst according to claim 1, comprising depositing the Pd metal compounds, and at least one of the Au metal compounds, Cd metal compounds, and Ba metal compounds, optionally reducing reducible metal compounds deposited on the support, washing to remove optionally present chloride content, impregnating with an alkali metal acetate or alkali metal compound which under reaction conditions during vinyl acetate monomer production convert wholly or partially to alkali metal acetates.

21. A process for the preparation of the supported catalyst according to claim 1 comprising impregnating the support with a basic solution and a solution which contains a gold salt and a palladium salt, wherein the impregnating takes place at the same time or sequentially, with or without intermediate drying, washing the support to remove optionally present chloride content and, before or after the washing, reducing the insoluble compounds precipitated on the support, to obtain a catalyst precursor, drying the catalyst precursor, and impregnating with an alkali metal acetate or alkali metal compound which under the reaction conditions during vinyl acetate monomer production convert wholly or partially to alkali metal acetate.

22. The process according to claim 20, wherein the alkali metal acetate or alkali metal compound is potassium acetate.

23. The process according to claim 21, wherein the alkali metal acetate or alkali metal compound is potassium acetate.

24. A process for the production of an unsaturated ester comprising reacting an olefin, organic acid and oxygen in the gas phase in the presence of a supported catalyst according to claim 1.

25. The process according to claim 24, wherein the unsaturated ester is vinyl acetate monomer.

26. A moulded body, comprising an annular cylindrical form, the cross section of which has a void and wherein free surface area of the void accounts for from 1.6 to 77% of total surface area of said moulded body.

27. A moulded body which is prepared from one or more pyrogenic oxides from the series SiO₂, Al₂O₃ and ZrO₂, characterised by an annular cylindrical form, whereof the cross section has a void and wherein free surface area of the void accounts for from 1.6 to 77% of the total surface area of the moulded body.

28. The moulded body according to claim 26, wherein the moulded body is prepared from pyrogenic mixed oxides, wherein at least two oxides from the group SiO₂, Al₂O₃, TiO₂ and ZrO₂ are used.

29. The moulded body according to claim 26, wherein the moulded body has the following physico-chemical characteristics:

| | | |
|---|---|---|
| External diameter | 3-8 | mm |
| Internal diameter | ≧1 | mm |
| Proportion of void surface area | 1.6-77% | |
| as % of total cross section: | | |
| BET surface area: | 5-400 | m²/g. |

30. The moulded body according to claim 26, made from pyrogenically prepared silicon dioxide having an annular cylindrical form, the cross section of which having a void and wherein free surface area of the void accounts for from 1.6 to 77% of the total surface area of said moulded body.

31. The moulded body according to claim 26, made from pyrogenically prepared silicon dioxide, wherein the moulded body has the following physico-chemical characteristics:

| | | |
|---|---|---|
| External diameter | 3-8 | mm |
| Internal diameter | ≧1 | mm |
| Proportion of void surface area | 1.6-77% | |
| as % of total cross section: | | |
| BET surface area: | 5-400 | m²/g. |
